(19) United States
(12) Patent Application Publication
(10) Pub. No.: US 2013/0015173 A1
(43) Pub. Date: Jan. 17, 2013

(54) LOCKOUT CIRCUIT WITH MANUAL RESET FOR RECREATIONAL VEHICLE HEATER

(71) Applicant: Philip R. Robinson, Wichita, KS (US)

(72) Inventor: Philip R. Robinson, Wichita, KS (US)

(73) Assignee: Airxcel, Inc., Wichita, KS (US)

(21) Appl. No.: 13/182,255

(22) Filed: Jul. 13, 2011

(51) Int. Cl. H05B 3/02; H02H 5/04

(52) U.S. Cl. 219/209; 361/103

(57) ABSTRACT

A lock-out circuit for preventing over-heating of a recreational vehicle heating system includes a temperature limit switch and a lock-out relay. The temperature limit switch is electrically coupled with the heating system and is operable to open when its temperature exceeds a threshold temperature and to reset and close when its temperature drops below the threshold temperature range. The lock-out relay has a contact electrically coupled with the temperature limit switch and a high impedance relay coil electrically coupled with the heating system in parallel with the temperature limit switch. The temperature limit switch and the lock-out relay remove substantially all power to the heating system when the temperature limit switch opens and re-establish power to the heating system only after the temperature limit switch has reset and voltage is at least temporarily removed from the lock-out relay.

### BACKGROUND

Many recreational vehicles (RVs) have heating systems and/or air conditioners that permit them to be comfortably used in all climates and seasons. Unfortunately, RV heating systems can overheat and pose a fire hazard when not maintained properly. Overheating can be caused by a variety of factors including dirty/clogged air filters, blocked return air vents, blocked or shut off supply registers, and/or defective or broken fans.

To prevent such overheating, the Underwriters Laboratory (UL) requires all RV air conditioners with electrical resistance heat to be equipped with a manually resettable temperature-limiting control switch or a replaceable single operation thermal cutoff or fusible link. These switches, fuses, or links disconnect power to their heating systems whenever their temperature exceeds a threshold and don't reconnect power until they are manually reset or replaced. The purpose of requiring a manually resettable or replaceable temperature-limiting device versus an automatic resettable device is to encourage the RV operator to find and remedy the source of the overheating problem while manually resetting or replacing the temperature-limiting device (or to quit using the heater until it is serviced and/or repaired). A related purpose of this requirement is to minimize the number of times the temperature-limiting device is reset to prevent contact welding that could result in additional fire risks.

Unfortunately, manually resettable or replaceable switches and links are difficult to operate because most RV heating systems are mounted in roof-top enclosures that are difficult to reach. Moreover, the switches or links are often positioned behind access panels, shrouds, or the like that must be removed in order to reset or replace them. Requiring operators to climb on top of their RVs to reset or replace these devices can also lead to accidents and injuries.

### SUMMARY

The present invention solves the above-described problems and other related problems by providing a temperature-limiting lockout circuit for an RV heater that complies with all UL requirements and that can be manually reset without accessing a roof-top enclosure or other hard to reach location on an RV.

The lock-out circuit of the present invention may be used with an RV heating system employing electric heat, such as an electrical resistance heater. The heating system may include an electrical heating element; a fan for passing air over the electrical heating element and into the recreational vehicle; a relay system for switching power to the electrical heating element and the fan; and a controller including switches and a thermostat for triggering the relay system.

An embodiment of the lock-out circuit is mounted in a roof-top enclosure of the heating system and broadly comprises a temperature limit switch and a lock-out relay. The temperature limit switch is electrically coupled with the electrical heating element of the heating system and is operable to open when its temperature exceeds a threshold temperature range and to reset and close when its temperature drops below the threshold temperature range. The lock-out relay has a normally-closed contact electrically coupled with the temperature limit switch and a high impedance relay coil electrically coupled with the heating element in parallel with the temperature limit switch.

When the temperature limit switch gets hot (thus indicating the heating system may be overheating as well), the switch opens to remove power to the heating system. When the temperature limit switch opens, the relay coil of the lock-out relay is placed in a series with the electrical heating element of the heating system. Because the impedance of the relay coil is much greater than the resistance of the electrical heating element, the voltage across the relay coil activates or opens the lock-out relay's normally closed contact. This prevents operating current from flowing through the temperature limit switch and to the electrical heating element even after the temperature limit switch has reset.

To re-establish power to the heating element two actions must occur: (1) the temperature limit switch must reset and close; and (2) voltage must be at least temporarily removed from the lock-out relay. The first action occurs automatically because the temperature limit switch resets and closes automatically once it cools. However, the second action requires manual intervention because the operator must manually remove voltage from the lock-out relay to reset it. In one embodiment, voltage may be temporarily removed from the lock-out relay by adjusting the thermostat of the controller to no longer call for heat or by switching the heating system off at the controller.

Importantly, neither of the two action described above alone can reconnect power to the heating system. If the operator removes voltage from the lock-out relay before the temperature limit switch has reset, the lock-out relay will simply re-activate and continue to prevent power delivery to the heating system. Similarly, if the temperature limit switch re-sets before the operator has removed voltage form the lock-out relay, the lock-out relay's contact will remain open and stay in the lock-out mode. Thus, power is only re-applied to the heating system after the temperature limit switch has reset and voltage is removed from the lock-out relay.

These and other embodiments of the invention described below provide numerous advantages over prior art RV temperature control devices. For example, the lock-out circuit of the present invention complies with all known UL requirements by requiring an RV operator to manually reset the circuit after the heating system overheats and therefore encourages the operator to locate the source of the overheating problem. However, the lock-out circuit does not require the operator to crawl on top of his or her RV and open the heating system's enclosure to do so. Moreover, embodiments of the lock-out circuit permit the operator to reset the circuit with an existing thermostat controller and thus do not require an additional control switch or other control device to be installed and wired into the RV.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURE

FIG. 1 is a schematic diagram of a lock-out circuit constructed in accordance with an embodiment of the invention and shown connected to an exemplary RV heating system.

The drawing figure does not limit the present invention to the specific embodiments disclosed and described herein. The drawing is not necessarily to scale, emphasis instead being placed upon clearly illustrating the principles of the invention.

### DETAILED DESCRIPTION

The following detailed description of embodiments of the invention references the accompanying drawing. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides a temperature-limiting lockout circuit for an RV heating system, such as may be incorporated in a roof-top air conditioner or elsewhere in the RV. The lock-out circuit complies with all known UL requirements and can be manually reset without accessing a roof-top enclosure or other hard to reach location on an RV. The lock-out circuit also does not require the installation of a dedicated reset button or other control switch in the RV to reset the circuit.

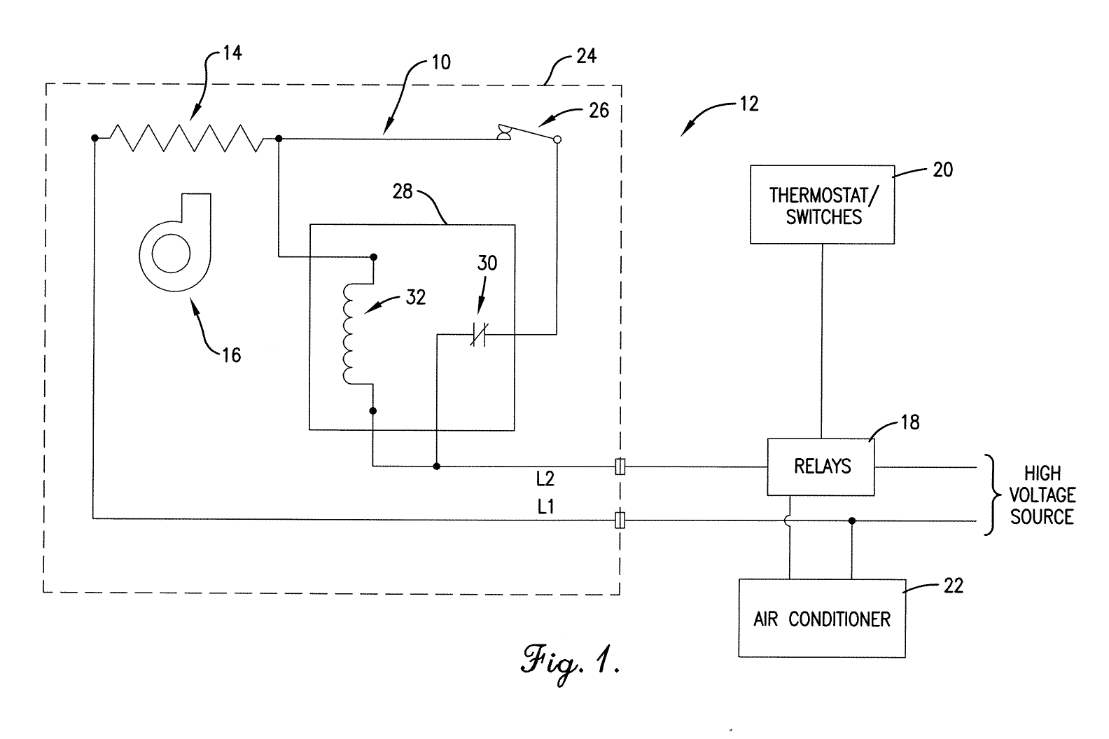

Turning now to FIG. 1, a lock-out circuit 10 constructed in accordance with embodiments of the invention and an exemplary heating system 12 in which the lock-out circuit may be installed are illustrated. The heating system 12 may be an electrical resistance type heater or any other electrical heater that includes an electrical heating element 14; a fan or blower 16 for passing air over the electrical heating element 14 and into the RV; a relay system 18 for switching power to the electrical heating element 14 and the fan 16; and a controller 20 including switches and a thermostat for triggering the relay system 18.

In one embodiment, the electrical heating element 14 is a 120 VAC, 1600 watt electric coil having a cold resistance of approximately 9.0 ohms, although it may have different ratings without departing from the scope of the present invention. The fan or blower 16 may be a stand-alone unit or may be integrated in an air handler that is connected to a duct system for delivering air to various locations within the RV. The relay system is provided for switching high voltage to the heating system 12 under direction of the controller 20 and may include a heating coil relay, a fan switch relay, a fan speed relay, a compressor relay, and other associated and conventional circuit elements. The controller 20 is provided for triggering the relay system 18 and thus the heating system 12 and may comprise a conventional thermostat controller with a temperature selecting slider or other switch and various fan control switches. The controller 20 may also be a programmable type temperature controller.

The heating system 12 may also include or be connected with an air conditioner 22. In one embodiment, the heating system 12 is part of a roof-top RV air conditioner such as the Coleman® Mach® air conditioner. Components of the heating system 12 may be positioned in a roof-top mounted enclosure 24 denoted by the dashed lines in FIG. 1.

The heating system 12 described and illustrated herein and its constituent components are merely examples of equipment and components that may be utilized to implement the principles of the invention and may be replaced with other equipment and/or components without departing from the scope of the appended claims.

The lock-out circuit 10 prevents over-heating of the heating system 12 by disconnecting power to the electrical heating element 14 whenever the temperature adjacent the lock-out circuit 10 exceeds a threshold level. An embodiment of the lock-out circuit 10 is mounted within the enclosure 24 and broadly includes a temperature limit switch 26 and a lock-out relay 28.

As shown in the drawing figure, the temperature limit switch 26 is electrically coupled with the electrical heating element 14 and is operable to open when its temperature exceeds a threshold temperature range and to reset and close when its temperature drops below the threshold temperature range. In one embodiment, the temperature limit switch 26 is a snap-action bimetal disc switch such as the Therm-O-Disc 60 T. The switch has an automatic resetting SPST switch configuration and opens when its temperatures rise above a threshold temperature of approximately 160-180° F. and resets and closes when it returns to a reset temperature of approximately 110° F.

The lock-out relay 28 has a normally-closed contact 30 electrically coupled with the temperature limit switch 26 and a high impedance relay coil 32 electrically coupled with the electrical heating element 14 in parallel with the temperature limit switch 26. In one embodiment, the lock-out relay is a 120 VAC, 15 amp relay with a normally closed SPST switch 30 and a relay coil 32 with an impedance of 2,500-3,025 ohms, although it may have different ratings without departing from the scope of the present invention. The lock-out relay 28 may be a Tyco T9CP2A52-120 relay, an American Zettler AZ2280-1B-120AF relay, or any equivalent or similar relay.

When the temperature limit switch 26 gets hot (thus indicating the heating system 10 may be overheating as well), the temperature limit switch 26 opens to remove power to the electrical heating element 14. When the temperature limit switch opens, the relay coil 32 of the lock-out relay 28 is placed in a series with the electrical heating element 14. Because the impedance of the relay coil 32 is much greater, normally more than one hundred times greater, than the resistance of the electrical heating element 14, the voltage across the relay coil 32 activates or opens the lock-out relay's normally closed contact 30. This prevents current from flowing through the temperature limit switch 26 even after the temperature limit switch 26 has reset. A minimal amount of current, on the order of 45 milliamps, but well below the amount of current required to operate the heating element 14, still flows through the electrical heating element 14 when the contact 30 is open.

To re-establish power to the electrical heating element 14 two actions must occur: (1) the temperature limit switch 26 must reset and close; and (2) voltage must be at least temporarily removed from the lock-out relay 28. The first action occurs automatically because the temperature limit switch 26 resets and closes automatically once it cools. However, the second action requires manual intervention because the operator must manually remove voltage from the lock-out relay 28 to reset it. In one embodiment, the operator may temporarily remove voltage from the lock-out relay 28 by adjusting the thermostat of the controller 20 to no longer call for heat or by switching the heating system 12 off at the controller 20.

Importantly, neither of the two actions described above alone can reconnect operating power to the electrical heating element 14. If the operator removes voltage from the lock-out relay 28 before the temperature limit switch 26 has reset, the lock-out relay 28 will simply re-activate and continue to prevent power delivery to the heating system 12. Similarly, if the temperature limit switch 26 re-sets before the operator has removed voltage form the lock-out relay 28, the lock-out relay's contact 30 will remain open and stay in the lock-out mode. Thus, operating power is only re-applied to the heating element 14 after the temperature limit switch has reset and voltage is removed from the lock-out relay 28.

The lock-out circuit 10 of the present invention as described herein provides numerous advantages over prior art RV temperature control devices. For example, the lock-out circuit 10 complies with UL requirements by requiring an RV operator to manually reset the circuit after the heating system overheats and therefore encourages the operator to locate the source of the overheating problem. However, the lock-out circuit 10 does not require the operator to crawl on top of the RV and open the heating system's enclosure to do so. Moreover, the lock-out circuit 10 permits the operator to reset the circuit with an existing heating system thermostat or controller 20 and thus does not require an additional switch or other control device to be installed and wired into the RV. The lock-out circuit 10 also minimizes the number of times the temperature limit switch 26 opens and closes and thus increases the life of the switch and decreases the risk of arc welding of the switch.

Although the invention has been described with reference to the embodiments illustrated in the attached FIG. 1, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A heating system for a recreational vehicle, the heating system comprising:
an electrical heating element;
a fan for passing air over the electrical heating element and into the recreational vehicle;
a relay system for switching power to the heating element and the fan;
a controller including switches and a thermostat for triggering the relay system; and
a lock-out circuit for preventing over-heating of the heating system, the lock-out circuit comprising—
a temperature limit switch electrically coupled with the electrical heating element and operable to open when its temperature exceeds a threshold temperature range and to reset and close when its temperature drops below the threshold temperature range; and
a lock-out relay having a contact electrically coupled with the temperature limit switch and a high impedance relay coil electrically coupled with the heating element in parallel with the temperature limit switch;
the temperature limit switch and the lock-out relay operable to remove substantially all power to the electrical heating element when the temperature limit switch opens and to re-establish power to the electrical heating element only after the temperature limit switch has reset and voltage is at least temporarily removed from the lock-out relay.

2. The heating system of claim 1, wherein an impedance of the relay coil of the lock-out relay is at least one hundred times a resistance of the electrical heating element.

3. The heating system of claim 1, wherein the contact of the lock-out relay is a normally closed contact.

4. The heating system of claim 1, wherein the electrical heating element is an electric resistance heating element.

5. The heating system of claim 1, wherein the electrical heating element is part of an air conditioner.

6. The heating element of claim 5, wherein the electrical heating element is an electric resistance heating element.

7. The heating system of claim 1, further including an evaporator coil, a condenser coil, and a compressor pump for pumping refrigerant gas between the evaporator coil and the condenser coil.

8. The heating system of claim 7, wherein the relay system includes a heating element relay, a fan switch relay, a fan speed relay, and a compressor pump relay.

9. A lock-out circuit for preventing over-heating of a recreational vehicle heating system, the lock-out circuit comprising:
a temperature limit switch configured to be electrically coupled with the heating system and operable to open when its temperature exceeds a threshold temperature and to reset and close when its temperature drops below the threshold temperature range; and
a lock-out relay having a contact electrically coupled with the temperature limit switch and a high impedance relay coil configured to be electrically coupled with the heating system in parallel with the temperature limit switch;
the temperature limit switch and the lock-out relay operable to remove substantially all operating power to the heating system when the temperature limit switch opens and to re-establish power to the heating system only after the temperature limit switch has reset and voltage is at least temporarily removed from the lock-out relay.

10. The lock-out circuit of claim 9, wherein an impedance of the relay coil of the lock-out relay is at least one hundred times a resistance of an electrical heating element of the heating system.

11. The lock-out circuit of claim 10, wherein the contact of the lock-out relay is a normally closed contact.

12. The lock-out circuit of claim 11, wherein the heating element is an electrical resistance heating element.

13. The lock-out circuit of claim 10, wherein the heating element is an electrical resistance heating element.

14. The lock-out circuit of claim 9, wherein the heating system is part of an air conditioner.

15. A heating system for a recreational vehicle, the heating system comprising:
a electrical heating element;
a fan for passing air over the electrical heating element and into the recreational vehicle;
a relay system for switching power to the electrical heating element and the fan;
a controller including switches and a thermostat for triggering the relay system;
a roof-top enclosure for housing the electrical heating element and the fan; and
a lock-out circuit positioned in the enclosure for preventing over-heating of the heating system, the lock-out circuit comprising—
a temperature limit switch electrically coupled with the electrical heating element and operable to open when its temperature exceeds a threshold temperature range and to reset and close when its temperature system drops below the threshold temperature range; and
a lock-out relay having a contact electrically coupled with the temperature limit switch and a high impedance relay coil electrically coupled with the electrical heating element in parallel with the temperature limit switch;
the temperature limit switch and the lock-out relay operable to remove substantially all power to the electrical heating element when the temperature limit switch opens and to re-establish power to the electrical heating element only after the temperature limit switch has reset and the controller has been operated to at least temporarily remove voltage from the lock-out relay.

16. The heating system of claim 15, wherein an impedance of the relay coil of the lock-out relay is at least one hundred times a resistance of the electrical heating element.

17. The heating system of claim 15, wherein the contact of the lock-out relay is a normally closed contact.

18. The heating system of claim 15, wherein the electrical heating element is in an electrical resistance heating element.

19. The heating system of claim 15, further including an evaporator coil, a condenser coil, and a compressor pump for pumping refrigerant gas between the evaporator coil and the condenser coil.

20. The heating system of claim 19, wherein the relay system includes a heating element relay, a fan switch relay, a fan speed relay, and a compressor pump relay.
